(19) United States
(12) Patent Application Publication
(10) Pub. No.: US 2002/0189692 A1
(43) Pub. Date: Dec. 19, 2002

(54) Joint fluid transport pipe

(75) Inventors: Taichi Sato, Osaka (JP); Kikuo Saito, Osaka (JP)

Correspondence Address: Russell D. Orkin, WEBB ZIESENHEIM LOGSDON , ORKIN & HANSON, P.C., 700 Koppers Building, 436 Seventh Avenue, Pittsburgh, PA, 15219-1818, US

(73) Assignee: WATERWORKS TECHNOLOGY DEVELOPMENT ORGANIZATION CO., LTD., Osaka (JP)

(21) Appl. No.: 09/881,567

(22) Filed: Jun. 13, 2001

(51) Int. Cl. F16K 11/076

(52) U.S. Cl. 137/625.47

(57) ABSTRACT

A fluid transport pipe joint for use in connecting a branch pipe to an existing fluid transport pipe is disclosed. The joint includes a joint body having first and second open ends connectable respectively with first and second ends of the fluid transport pipe formed by cutting away a predetermined length portion from the pipe, and a third open end connectable with the branch pipe, a pair of seal rings fitted over the first and second ends of the fluid transport pipe, the seal rings being slidable over an outer peripheral face of the fluid transport pipe so as to respectively seal a border portion between the first open end of the joint body and the first end of the fluid transport pipe and a border portion between the second open end of the joint body and the second end of the fluid transport pipe, a valve disposed inside the joint body to be pivotable therein to control flow of fluid running inside the joint body, and a seat provided within the joint body. The seat includes a third seat portion for contacting and supporting the valve at a predetermined angular position of the valve in such a way as to shut the third open end of the joint body from the fluid running between the first open end and the second open end, a first seat portion for contacting and supporting the valve at a further predetermined angular position of the valve in such a manner as to shut the first open end from the fluid running between the second open end and the third open end, and a second seat portion for contacting and supporting the valve at a still further predetermined angular position of the valve in such a manner as to shut the second open end from the fluid running between the third open end and the first open end.

### BACKGROUND OF THE INVENTION

1. Field of the Invention

The present invention relates to a joint for a fluid transport pipe for use in connecting a branch pipe to an existing fluid transport pipe.

2. Description of the Related Art

A fluid transport pipe joint of the above-noted type is known fiom e.g. Japanese registered utility model No. 2502619.

This conventional joint includes:

a joint body having first and second open ends connectable respectively with first and second ends of the fluid transport pipe formed by cutting away a predetermined length portion from the pipe, and a third open end connectable with a branch pipe;

a pair of seal rings fitted over the first and second ends of the fluid transport pipe, the seal rings being slidable over an outer peripheral face of the fluid transport pipe so as to respectively seal a border portion between the first open end of the joint body and the first end of the fluid transport pipe and a border portion between the second open end of the joint body and the second end of the fluid transport pipe;

a valve disposed inside the joint body to be pivotable therein to control flow of fluid running inside the joint body; and

a seat provided within the joint body, the seat including a seat portion for contacting and supporting the valve at a predetermined angular position of the valve in such a way as to shut the third open end of the joint body from the fluid running between the first open end and the second open end, the seat including, in addition to the seat portion, only another seat portion for contacting and supporting the valve at a further predetermined angular position of the valve in such a manner as to shut the first open end from the fluid running between the first open end and the second open end.

A typical case of using such fluid transport joint pipe is a following case implementing a “non-water-stop” method for effecting a certain treatment (repair or removal) on a damaged or defective portion F present midway in an existing water pipe (an example of “fluid transport pipe”). The “non-water-stop” method means that the target treatment is to be carried out continuously without requiring temporal suspension of water supply in the fluid transport pipe. The implementation of a process in this method is illustrated in FIG. 8.

According to this method, for example, as illustrated in FIG. 8(a), a pair of cutting portions 1a, 1b are set at two appropriate distant points A, B across the defective portion F in the fluid transport pipe 1. Then, a pair of seal rings (not shown in FIG. 8, but shown in FIG. 7 showing a conventional fluid transport pipe joint 103, denoted with reference numerals 150, 150) are fitted on the pipe at positions slightly outward in the pipe axis direction relative to the two cutting positions.

Thereafter, a water-tight sealed casing (same as one denoted with reference numeral 60 in FIG. 6) is placed over and around the two cutting points A, B, including the seal rings, then, the predetermined lengths of cutting pipe portions 1a, 1b are cut away (the cutting method will be detailed later in the description of the present invention about a fluid transport pipe 3).

Then, as illustrated in FIG. 8 (b), taking the position A for example, the straight pipe portion of the fluid transport pipe joint 103 is aligned with the first and second ends of the fluid transport pipe formed by the cutting-away of the pipe portion 1a. In this case, the angular position is fixedly set to shut the third open end from the fluid running between the first open end and the second open end.

Subsequently, a manipulator rod 60s (shown in FIG. 6 showing the water-tight sealed casing 60 which is employed both in the conventional joint and the invention's joint) extending from the outside of the sealed casing to the pair of seal rings 150, 150 is manipulated to move the pair of seal rings to the respective border portions between the straight pipe portion of the joint body and the remaining portions of the fluid transport pipe, whereby the straight pipe portion of the joint 103 and the fluid transport pipe 1 are connected to each other temporarily.

Then, as illustrated in FIG. 8 (c), a bypass pipe 102 for bypassing the defective portion F is connected to a branch pipe portion 106 (shown in FIG. 7) of the respective fluid transport pipe joint 103.

Next, as illustrated in FIG. 8 (d), the valve 118 of each joint is manually operated to its predetermined angular position for shutting the first open end from the fluid running between the second open end and the third open end (in other words, for insulating alone a portion 1Q of the pipe including the deflective portion F).

With the last-mentioned operation, the fluid inside the fluid transport pipe 1 begins to run from the upstream to the downstream side through the newly connected bypass pipe 102, with no fluid running into the portion 1Q of the pipe 1 including the defective portion F.

Thereafter, the defective portion F may be repaired with no water supply thereto, so that the repaired fluid transport pipe may be re-used after the bypass pipe 102 is removed. Or, the pipe portion 1Q including the defective portion may be eliminated permanently and the bypass pipe 102 may be used instead thereafter as a portion of the fluid transport pipe.

However, as described hereinbefore and as illustrated in FIG. 7, with the conventional fluid transport pipe joint 103, the seat 140 includes a seat portion 140a for contacting and supporting the valve 118 at a predetermined angular position of the valve in such a way as to shut the third open end 106a of the joint body from the fluid running between the first open end 105a and the second open end 105b. And, in addition to this seat portion 140a, the seat includes only another seat portion 140b, 140b for contacting and supporting the valve 118 at a further predetermined angular position of the valve in such a manner as to shut the second open end 105b fiom the fluid running between the first open end 105a and the third open end 106a.

Therefore, it is necessary to prepare two different types of fluid transport pipe joints 103L, 103R (different in particular in the shape of the seat), i.e. the left fluid transport pipe joint 103L (in which the first open end 105a is disposed on the left side and the second open end 105b is disposed on the right side) which can be used only for the left-side branching portion A in FIGS. 8 (a)-(e) and the right fluid transport pipe joint 103R (in which the first open end is disposed on the right side and the second open end 105b is disposed on the left side). This is said to add to the manufacture costs of the fluid transport pipe joint or to complicate the inventory control of the fluid transport pipe joints.

Regarding the above-described problem, it is conceivable to mount one of the fluid transport pipe joints with its vertically reversed orientation, so as to use this right fluid transport pipe joint as a substitute for a left joint. However, if the fluid transport pipe is a large-diameter pipe buried in the ground, a very large-scale digging work will be needed (i.e. a huge working space under the vertically reversed fluid transport pipe joint needs to be formed, and also a pit needs to be dug out on the lateral sides of the fluid transport pipe joint in order to allow access to this working space). Hence, such method cannot be implemented in practice.

### SUMMARY OF THE INVENTION

Then, in a fluid transport pipe joint needed for forming a bypass pipe bypassing a predetermined portion in the non-stop method without temporal suspension of fluid transport for the purpose of effecting a certain treatment to a defective portion (F) present in midway of an existing water supply pipe or the like, the primary object of the present invention is to provide a fluid transport pipe joint which does not require preparation of two types of joints of different shapes for e.g. the left-hand use and the right-hand use.

For accomplishing the above-noted object, according to the present invention, there is provided a fluid transport pipe joint for use in connecting a branch pipe to an existing fluid transport pipe, comprising:

a joint body having first and second open ends connectable respectively with first and second ends of the fluid transport pipe formed by cutting away a predetermined length portion from the pipe, and a third open end connectable with the branch pipe;

a pair of seal rings fitted over the first and second ends of the fluid transport pipe, the seal rings being slidable over an outer peripheral face of the fluid transport pipe so as to respectively seal a border portion between the first open end of the joint body and the first end of the fluid transport pipe and a border portion between the second open end of the joint body and the second end of the fluid transport pipe;

a valve disposed inside the joint body to be pivotable therein to control flow of fluid running inside the joint body; and

a seat provided within the joint body;

wherein the seat includes;

a third seat portion for contacting and supporting the valve at a predetermined angular position of the valve in such a way as to shut the third open end of the joint body from the fluid running between the first open end and the second open end,

a first seat portion for contacting and supporting the valve at a further predetermined angular position of the valve in such a manner as to shut the first open end from the fluid running between the second open end and the third open end, and

a second seat portion for contacting and supporting the valve at a still further predetermined angular position of the valve in such a manner as to shut the second open end fiom the fluid running between the third open end and the first open end.

Therefore, according to the fluid transport pipe joint provided by the present invention, in cooperation with each of the first, second and third seat portions, in addition to a posture for shutting the third open end from the fluid running between the first open end and the second open end, the valve can also take, when needed, another posture for shutting the first open end from the fluid running between the second open end and the third open end and still another posture for shutting the second open end fiom the fluid running between the first open end and the third open end. Then, when forming, by the non-water-stop method, a bypass pipe for bypassing a predetermined pipe portion between two positions of a fluid transport pipe for the purpose of e.g. effecting a certain treatment (repair, removal, etc.) to a defective portion (F) present in midway of an existing water supply pipe or the like, the above-described pipe joint can be used in such connection portion. Also, since this joint can be used both as the right-hand device and the left-hand device, it is unnecessary to prepare two types of fluid transport pipe joints of different constructions. As a result, the manufacture costs of the fluid transport pipe joint are reduced and the inventory control of the fluid transport pipe joints becomes easier.

In addition to the above-described advantages, the fluid transport pipe joint provided by the present invention achieves another major advantage as follows. Namely, when this joint is used as the left-hand branching portion fluid transport pipe joint shown in FIG. 8, if necessary, by setting its valve to the left-hand angular position (i.e. the upstream side in the flow of the fluid), this joint can be used as a “cutoff” valve” for completely shutting the flow of the fluid toward the right-hand branching portion.

Preferably, the valve includes an elastic seal, each of the seat portions contacting and supporting the valve via the elastic seal of the valve, and each of the seat portions includes a chamfered portion for smoothly receiving the elastic seal at each angular position of the valve by each seat portion.

With the above construction, when the elastic seat provided for assuring reliable shutting of the fluid by the valve rides over the seat portion, the elastic seal can restrict damage due to e.g. friction with an end of the seat portion.

Also preferably, there is provided a valve rod for rotatably manipulating the valve from the outside of the joint body, the valve rod being provided separately from the valve and being coupled with the valve by fastening means.

With this construction, the valve and the valve rod may be formed of different materials from each other. As a result, each of the valve and the valve rod may be formed of a material most suitable for the respective function thereof. Specifically, the valve, which has a rather complicated configuration, can be formed integrally of cast iron by casting iron in a single mold. Whereas, the valve rod, which has more simple configuration, can be formed integrally of stainless steel. Namely, when the valve is rotatably manipulated, a very large torque is required for the valve rod. Then, if this rod is formed of stainless steel having great toughness, it can withstand such torque sufficiently. Further, according to the conventional practice, the valve and the valve rod would be formed integrally as a whole by means of casting. Then, the shape of the runner channel formed in the single mold would be complicated, thus tending to invite e.g. formation of shrinkage cavity. As a result, the valve rod (portion) of the finished product would often have some portions which are insufficient in strength to withstand the torque applied during the rotational manipulation of the valve. On the other hand, according to the present invention, only the valve is formed by casting. Therefore, the possibility of formation of shrinkage cavity in the portion subjected to the significant torque is avoided. Hence, it has become possible to provide the entire valve with sufficient strength for withstanding the torque applied during the rotational manipulation of the valve.

Still preferably, the valve rod includes a flange portion having a plurality of screw holes and a valve rod body continuously extending from the flange portion, the valve rod body including a manipulation input portion for receiving the rotational manipulating force from the outside of the joint body.

With this construction, the valve rod is to be coupled with the valve via the flange portion having a greater diameter. So that, it becomes possible to effectively transmit a large torque required for rotationally manipulating the valve to the valve from the valve rod.

Further and other features and advantages of the invention will become apparent from the following discussion of the preferred embodiment thereof with reference to the accompanying drawings.

### BRIEF DESCRIPTION OF THE DRAWINGS

FIG. 1 is plan view in horizontal section of a fluid transport pipe joint according to the present invention,

FIG. 2 is a plan view in horizontal section showing the fluid transport pipe joint of FIG. 1 under a different condition,

FIG. 3 is a side view in vertical section of the fluid transport pipe joint of FIG. 1,

FIG. 4 is an exploded perspective view schematically showing principal portions of the fluid transport pipe joint of FIG. 1,

FIGS. 5 (a) through (e) are schematic diagrams illustrating respective steps of a “non-water-stop” bypass pipe forming method using the fluid transport pipe joint according to the present invention,

FIGS. 6 (a) through (d) are schematic diagrams illustrating further steps of the non-water-stop bypass pipe forming method using the fluid transport pipe joint according to the present invention,

FIG. 7 is a plan view in section showing a conventional fluid transport pipe joint for use as a left-hand device, and

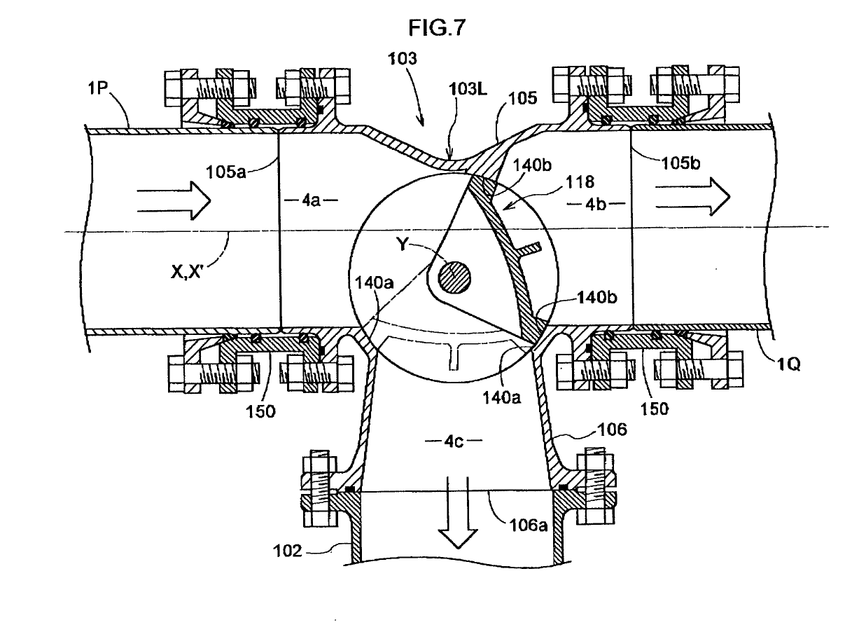

FIGS. 8 (a) through (e) are schematic diagrams illustrating respective steps of the non-water-stop bypass pipe forming method using the conventional fluid transport pipe joint.

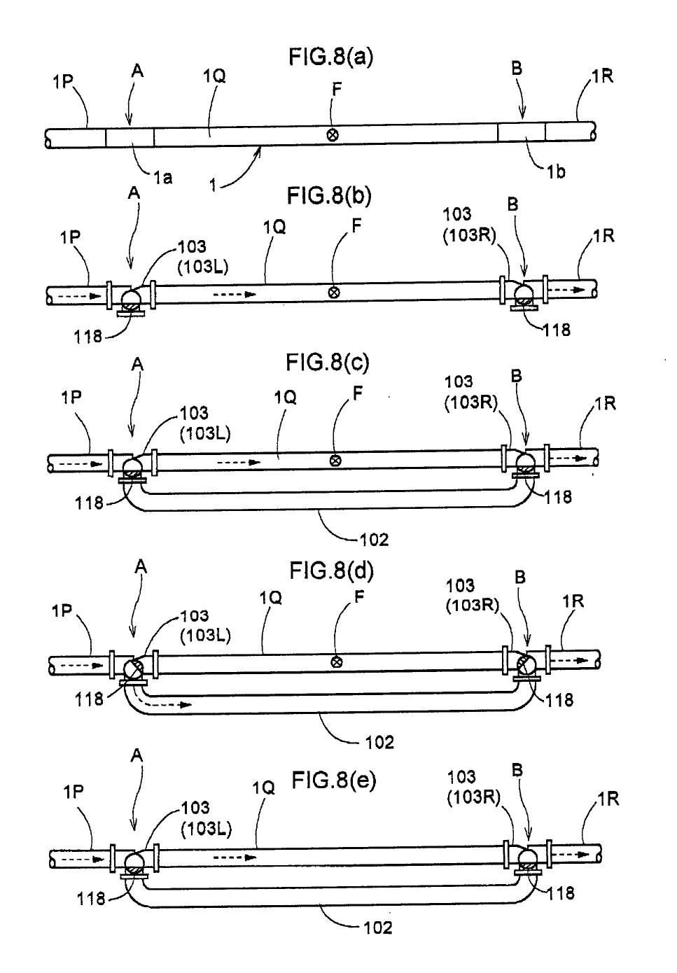

### DESCRIPTION OF THE PREFERRED EMBODIMENT

A preferred embodiment of a fluid transport pipe joint according to the present invention will be described with reference to the accompanying drawings. The following discussion is based on implementation of the non-water-stop bypass pipe forming method using the joint of the invention.

### Brief Description of the Non-Water-Stop Bypass Pipe Forming Method

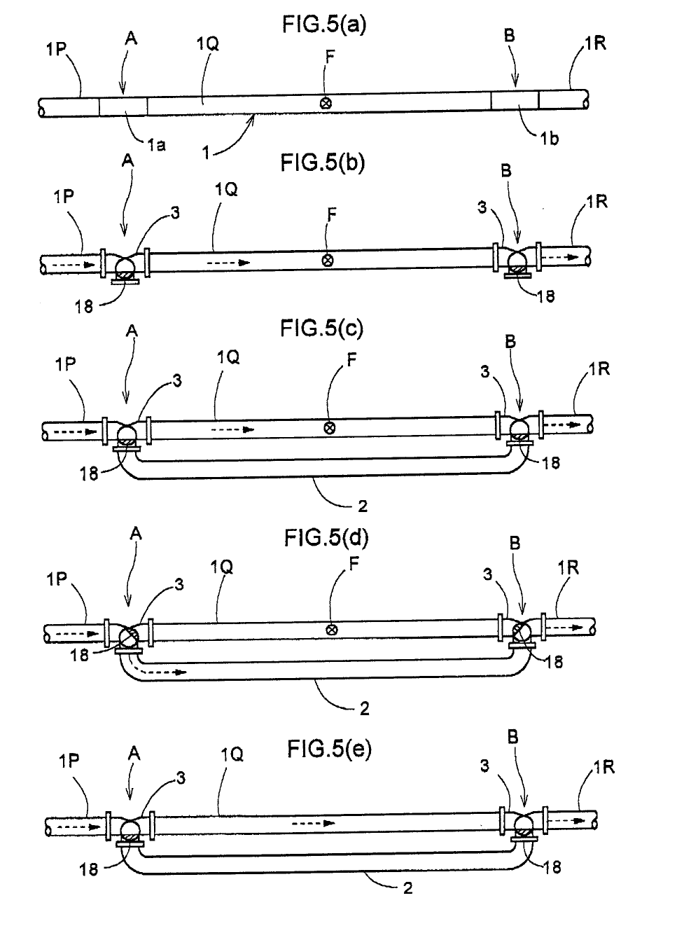

This non-water-stop bypass pipe forming method is directed to an existing water supply pipe 1 (an example of “fluid transport pipe”) shown in FIG. 5 (a). In this method, first, two points A, B disposed apart from each other across a defective portion F present in the existing water supply pipe 1 are selected and pipe portions 1a, 1b corresponding in length respectively to the points A, B are cut away by a method to be described later. And, as illustrated in FIG. 5 (b), in place of the cutaway pipe portions 1a, 1b, fluid transport pipe joints 3, 3 are mounted thereto, so that via these fluid transport pipe joints 3, 3, a bypass pipe 2 (an example of “branch pipe”) is mounted for bypassing the defective portion F.

As illustrated in FIG. 5 (c), after the bypass pipe 2 is formed, first, as illustrated in FIG. 5 (d), this bypass pipe 2 maintains the water supply from an upstream portion 1P to a downstream portion 1R of the remaining existing water-supply pipe 1. At the same time, in order to stop water supply to a pipe portion 1Q between the points A, B, a passage switchover valve incorporated in each of the fluid transport pipe joints 3, 3 is manipulated. Next, under this water-stopped condition, the defective portion F is repaired. After completion of the repair, as illustrated in FIG. 5 (e), the passage switchover valves are again manipulated so as to supply water again to the pipe portion 1Q and also to stop water supply to the bypass pipe 2. Then, if needed, the pipe portion 1Q may be dislodged.

### Construction of the Fluid Transport Pipe Joint)

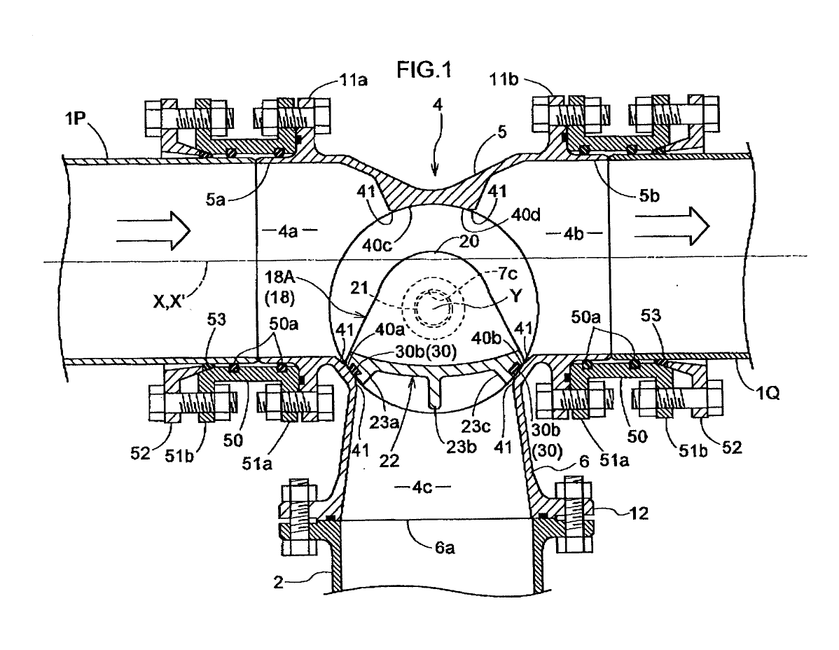

As shown in FIGS. 5 (a) through (d), the two fluid transport pipe joints 3, 3 used at the points A, B are of identical shape and construction. As shown in FIGS. 1-4, the fluid transport pipe joint 3 consists mainly of a T-shaped joint body 4 and a valve 18 pivotably mounted inside the joint body 4 for controlling passage of fluid inside the joint body 4. The joint body 4 is made of cast iron and provided as an integrally cast unit including a straight pipe portion a having an axis X, a branch pipe portion 6 extending laterally (i.e. perpendicularly relative to the axis X) from a portion of the peripheral face of the straight pipe portion 5 and a valve box portion 7 extending perpendicularly relative to a plane including both the straight pipe portion 5 and the branch pipe portion 6.

The straight pipe portion 5 includes first and second open ends 5a, 5b opposing to each other. During its use, once the first and second open ends 5a, 5b are connected to the upstream portion 1P and the downstream portion 1R of the remaining existing water supply pipe 1, the axis X of the straight pipe portion 5 is aligned with the axis X′ of the existing water supply pipe 1 as a result of the connection. Inside the first and second open ends 5a, 5b, there are respectively formed first and second passages 4a, 4b.

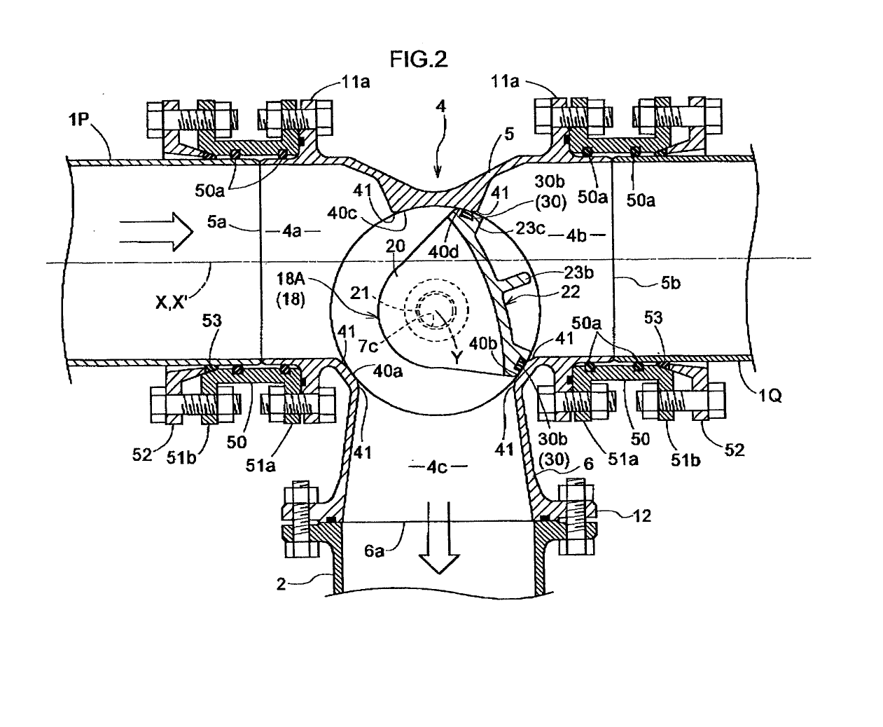

The straight pipe portion 5, the branch pipe portion 6 and the valve box portion 7 are all communicated with each other inside the joint body 4. And, a third open end 6a is formed at the leading end of the branch pipe portion 6. Also, as shown in FIGS. 1 and 2, an axis Y of the valve box portion 7 is significantly offset from the axis X of the straight pipe portion 5 toward the leading end of the branch pipe portion 6. Inside the third open end 6a, a third passage 4c is formed.

Inside the valve box portion 7, a valve 18 is mounted to be pivotable about the axis Y. The valve 18 is mounted by being inserted downward from an opening 7a formed at the upper end of the valve box portion 7. After mounting of the valve 18, the opening 7a of the valve box portion 7 is closed by a valve box lid 8. For this purpose, at the upper end of the valve box portion 7, there is integrally formed a flange portion 7b defining a plurality of though holes, whereas the valve box lid 8 also defines the same number of corresponding through holes, so that the valve box lid 8 is fastened in water-tight manner to the valve box portion 7 by bolt means inserted into the respective through holes thereof.

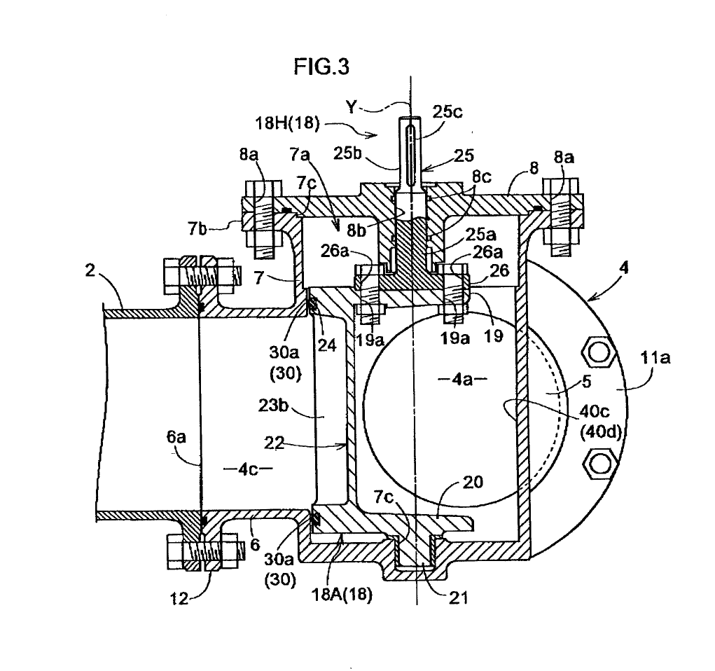

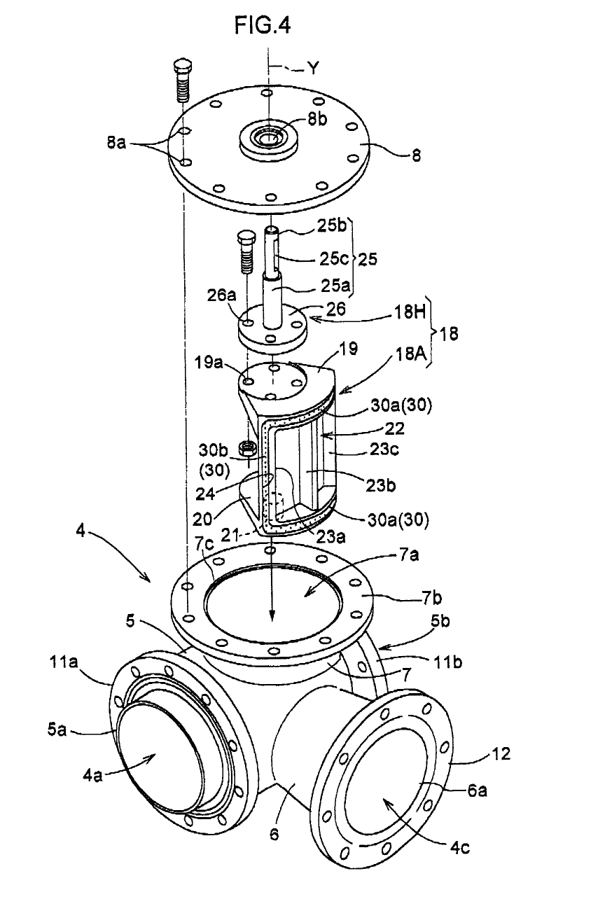

As shown in FIGS. 3 and 4, the valve 18 includes a valve body 18A integrally formed of cast iron and a valve rod 18H made of stainless steel (e.g. SUS403) connected to the body 18A by means of bolts threaded into four screw holes defined at the upper portion of the valve body 18A.

The valve body 18A consists mainly of a pair of upper and lower substantially fan-shaped arm portions 19, 20 extending horizontally and a valve face portion 22 interconnecting the arm portions 19, 20 together. The valve face portion 22 integrally forms three reinforcing ribs 23a, 23b, 23c. The upper arm portion 19 defines four screw holes 19a.

At respective radially outer end faces of the pair of arm portions 19,20 and also at respective radially outer end faces of the left and right reinforcing ribs 23a, 23c, there is defined a groove 24 for receiving a sealing rubber therein. Specifically, in this groove 24, an endless sealing rubber element 30 is fitted. This sealing rubber element 30 includes a pair of horizontal portions 30a, 30a disposed one above the other and a pair of vertical portions 30b, 30b.disposed on the right and left. These portions together form a substantially rectangular-shaped sealing area. As may be understood from FIG. 3, the groove 24 has a cross sectional shape like a trapezoid having a bottom face wider than the top opening thereof. Referring more particularly to this cross sectional shape of the groove 24, this shape consists of a base portion corresponding substantially the cross sectional shape of the groove 24 and an arc-like leading end projecting fiom the center of the upper side of the base. Once the sealing rubber element 30 is fitted into the groove 24, there is realized a condition in which only the arc-like leading end projects from the respective radially outer ends of the arm portions 19, 20 and the respective radially outer ends of the left and right reinforcing ribs 23a, 23c.

The valve rod 18H consists essentially of a flange portion 26 defining four screw holes 26a and a valve rod body 25. The valve rod body 25 consists of a base end portion 25a extending integrally and vertically upward fiom the center of the flange portion 26 and a leading end manipulating portion 25b extending integrally and further upward from the base end portion 25a. The manipulating portion 25b defines at a portion of its peripheral face a vertically extending key groove 25c (an example of “a manipulation input portion” herein). The base end portion 25a of the valve rod body 25 may be formed integrally, by means of welding, with the flange portion 26. The valve rod 18H and the valve body 18A are fixed together by means of four pairs of bolts/nuts (an example of “fastening means” herein).

Further, as shown in FIGS. 3 and 4, the valve 18 is supported to be pivotable about the axis Y in such a manner that the base end portion 25a of the valve rod 18H is supported at a support through hole 8b defined at the center of the valve box portion 8 and a shaft portion 21 extending from the lower end of the valve is supported at a support recess 7c defined in the bottom of the valve box portion 7. The support through hole 8b of the valve box lid 8 defines an annular groove 8c in the inner peripheral face thereof, into which a rubber O-ring (not shown) is fitted for realizing a water-tight condition.

At the leading ends of the first and second open ends 5a, 5b of the joint body 4, there are formed sealed cylindrical portions 6a, 5b having an outer diameter corresponding to the outer peripheral face of the existing water supply pipe 1. And, these sealed cylindrical portions 5a, 5b form, adjacent respective base ends thereof, flanges 11a, 11b defining bolt through holes. On the other hand, at the leading end of the third open end 6a of the joint body 4, there is formed a flange 12 having bolt through holes.

The valve box portion 7 forms, in its inner surface, a seat face 40 (an example of “seat”) capable of contacting and supporting the sealing rubber element 30 of the valve body 18A according to the pivotal position of the valve 18 about the axis Y. As shown in FIGS. 1 and 2, the seat face 40 consists of a first seat face portion 40a vertically extending at a position where the first open end 5a of the joint body 4 and the base end of the branch pipe portion 6 intersect each other, a second seat face portion 40b vertically extending at a position where the second open end 5b of the joint body 4 and the base end of the branch pipe portion 6 intersect each other and third and fourth seat face portions 40c, 40d vertically extending at positions facing the base end of the branch pipe portion 6. The third and fourth seat face portions 40c, 40d are formed continuously adjacent each other. Further, the third seat face portion 40cc is disposed closer to the side of the first seat face portion 40a along the inner peripheral face of the valve box portion 7, while the fourth seat face portion 40d is disposed closer to the side of the second seat face portion 40b along the inner peripheral face of the valve box portion 7.

In operation, with application of a rotational manipulating force applied externally through the manipulating portion 25b of the valve rod 18H, the valve 18 is pivoted about the axis Y to be selectively rendered into the following positions;

a third position wherein the pair of vertical portions 30b, 30b of the sealing rubber element 30 are brought into tight contact with the first seat face portion 40a and the second seat face portion 40b to be supported thereby, so that the third passage 4c is closed, while allowing free movement of the fluid between the first and second passages 4a, 4b;

a first position wherein the pair of vertical portions 30b, 30b of the sealing rubber element 30 are brought into tight contact with the first seat face portion 40a and the third seat face portion 40c to be supported thereby, so that the first passage 4a is closed, while allowing free movement of the fluid between the second and third passages 4b, 4c; and

a second position wherein the pair of vertical portions 30b, 30b of the sealing rubber element 30 are brought into tight contact with the second seat face portion 40b and the fourth seat face portion 40d to be supported thereby, so that the second passage 4b is closed, while allowing free movement of the fluid between the first and third passages 4a, 4c.

In other words, the first seat face portion 40a and the second seat face portion 40b together constitute “a third seat portion” for contacting and supporting the valve 18 so as to shut the third passage 4c from the fluid running between the first and second passages 4a, 4b. The first seat face portion 40a and the third seat face portion 40c together constitute “a first seat portion” for contacting and supporting the valve 18 so as to shut the first passage 4a from the fluid running between the second passage 4b and the third passage 4c. Further, the second seat face portion 40b and the third face portion 40c together constitute “a second seat portion” for contacting and supporting the valve 18 so as to shut the second passage 4b from the fluid running between the third passage 4c and the first passage 4a.

Each of the first second, third and fourth seat face portions 40a, 40b, 40c, 40d includes a chamfered portion 40 for smoothly receiving the sealing rubber element 30 for restricting damage in the sealing rubber element 30. This chamfered portion 40 forms an inclination of about 30 degrees relative to the effective surface of the respective seat face portions 40a, 40b, 40c, 40d.

Further, the fluid transport pipe joint also includes a pair of seal rings 50 fitted over the upstream portion 1P and the downstream portion 1r of the existing water pipe 1. The seal rings 50 are slidable over the outer peripheral face of the existing water pipe 1 so as to respectively seal a border portion between the first open end 5a of the joint body 4 and the upstream portion 1P of the existing water pipe 1 and a border portion between the second open end 5b of the joint body 4 and the downstream portion 1r of the existing water pipe 1. FIGS. 1 and 2 shows these seal rings 50 mounted already over both the straight pipe portion 5 of the fluid transport pipe joint 3 and the remaining water pipe 1.

### Example of Non-Water-Stop Bypass Pipe Forming method

(1) At each of the upstream portion 1P and the downstream portion 1R of the existing water supply pipe 1, the pair of seal rings 50 are fitted over a portion of the pipe 1 slightly on the outer side of the cutting portion thereof (the portion to be cut away). For this purpose, the seal ring 50 can be divided into two parts.

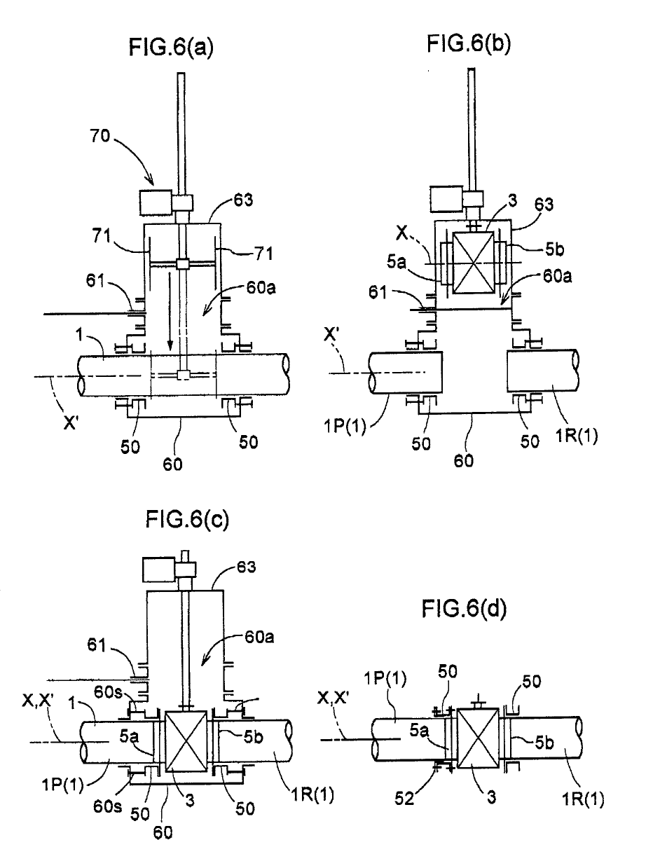

(2) Next, as shown in FIG. 6 (a), at each of the upstream portion 1P and the downstream portion 1R of the existing water supply pipe 1, the water-tight sealed casing 60 is fitted over the water pipe 1, including the pair of seal rings 50 fitted thereon. This sealed case 60 is means for forming a water-tight sealed space between the case and the outer peripheral face of the pipe 1. So, this case 60 can be divided peripherally into a plurality of parts so that the case can be mounted and dismounted relative to the existing water supply pipe 1. At an upper portion of this sealed casing 60, there is defined a pipe access opening 60a, and to an end face of this pipe access opening 60a, there is attached a water-stop case 60 housing a cutter device 70 (described later) therein. Incidentally, an opening-closing valve 61 is attached to the pipe access opening 60a for closing this opening 60a. The cutter device 70 includes a pair of endless-chain like cutters 71, 71 with these cutters 71, 71 being apart from each other by a distance corresponding to the length of the cutting portions 1a, 1b to be cut.

(3) As indicated by an arrow in FIG. 6(a), while the opening-closing valve 61 is opened, the cutter device 70 is lowered from the water-stop case 63 into the sealed case 60. Then, at a point A in the upstream portion 1P and at a point B in the downstream portion 1R of the existing water supply pipe 1, each portion of the water pipe 1 is cut away by using the chain-like cutters 71, 71. Upon this cutting, water will gush out of the water pipe 1, but will be contained within the sealed case 60 and the water-stop case 63, not leaking to the outside.

(4) The cutter device 70 is lifted into the water-stop case 63 together with the cut pipe portion 1a, 1b and the opening-closing valve 61 is closed. Then, the water-stop case 63 and the cutter device 70 are together detached from the sealed case 60.

(5) As shown in FIG. 6 (b), the water-stop case 63 accommodating the fluid transport pipe joint 3 therein is attached to the sealed case 60. In succession, the opening-closing valve 61 is opened and, as shown in FIG. 6 (c), the fluid transport pipe joint 3 is lowered into the sealed case 30 (in this condition, the fluid transport pipe joints 3 used respectively at the point A and the point B are entirely of the same shape and the valve 18 in each joint 3 is set at the third position described above). Subsequently, by aligning the axis X of the straight pipe portion 5 of the fluid transport pipe 3 with the axis X′ of the existing water supply pipe 1, the first and second open ends 5a, 5b of the straight pipe portion 5 are brought into flush with the upstream portion 1P and the downstream portion 1R of the remaining water pipe 1.

(6) Then, by operating the manipulating rod 60s provided to the sealed case 60, each seal ring 50 (provided at four positions in total) is slid by a predetermined distance in the direction of the fluid transport pipe joint 3. With this, the upstream seal ring 50 will be set over the border between the first open end 5a of the straight pipe portion 5 and the upstream portion 1P of the existing water supply pipe 1 and the downstream seal ring 50 will be set over the border between the second open end 5b of the straight pipe portion 5 and the downstream portion 1R of the water pipe 1, respectively. Since in the inner peripheral face of each seal ring 50 there are provided a pair of packing 50a disposed apart from each other in the axial direction, between the upstream portion 1P and the downstream portion 1r of the remaining water pipe 1 and the fluid transport pipe joint 3, there is obtained a sealed condition which is not perfect, but sufficient to prevent leak of water.

(7) As shown in FIG. 6 (d), the sealed case 60 and the water-stop case 63 are dismounted from the upstream portion 1P and the downstream portion 1R of the existing water supply pipe 1, respectively. In succession, as shown in e.g. FIG. 1, a first flange 51a provided to the inner side of each seal ring 50 is fastened to the flanges 11a, 11b of the straight pipe portion 5 of the joint 3 by means of bolts and nuts. Further, a press ring 52 is attached to a second flange 51b provided on the outer side of each seal ring 50 and then these are fastened to the first flange 51a, so that a wedge-like packing 53 attached to the leading end of the press ring 52 is pressed between the receiving inclined face formed on the outer side of each seal ring 50 and the upstream portion 1P (or downstream portion 1R) of the existing water pipe 1. With this, as shown in FIG. 5 (b), a pair of fluid transport pipe joints 3 are installed at the point A and point B.

(8) Next, as shown in FIG. 5 (c), to each branch pipe portion 6 of the pair of fluid transport pipe joints 3 installed at the points A, B, the bypass pipe 2 is connected.

(9) As shown in FIG. 5 (d), the valves 18 of the two fluid transport pipe joints 3 are switched over to the first position (the valve 18 of the joint 3 installed at point A will be oriented to the right side and the valve 18 of the joint 8 installed at point B will be oriented to the left side, respectively). With these switching operations, the water in the water pipe 1 flows from the upstream portion 1P via the bypass pipe 2 to the downstream portion 1R. In this, the smooth concave inner face configuration of the valve face member 22 provides a rectifying effect for reducing the resistance experienced by the running water when the valve 18 is set to the second or third position.

(10) Thereafter, the deflective portion F between the points A, B is repaired. Or, the pipe portion between the points A, B of the existing water supply pipe 1 is replaced by a new one without any defect.

(11) As shown in FIG. 5 (e), both the valve 18 of the joint 3 installed at point A and the valve 18 of the joint 3 installed at point B are returned to the first position. With this, the water in the water pipe 1 begins to flow, not in the bypass pipe 2, but straight from the upstream portion 1P via the repaired pipe portion 1Q to the downstream portion 1R.

(12) After the above, the bypass pipe 2 may be removed permanently, or may be left there. When the bypass pipe 2 is eliminated, by closing the branch pipe portion 6 of each fluid transport pipe joint 3 with e.g. a blind lid (not shown), it is possible to prevent leakage of water from the branch pipe portion 6 due to damage resulting from e.g. aging of the sealing rubber element 30 of the valve 18.

The invention may be embodied in any other way than described above. The foregoing embodiment is not to limit the scope of the invention to the constructions shown in the accompanying drawings, but only to illustrate one preferred mode of embodying the invention. Further and other modifications will be readily made by one skilled in the art without departing from the scope of the invention set forth in the appended claims.

What is claimed is:

1. A fluid transport pipe joint for use in connecting a branch pipe to an existing fluid transport pipe, comprising:
a joint body having first and second open ends connectable respectively with first and second ends of the fluid transport pipe formed by cutting away a predetermined length portion from the pipe, and a third open end connectable with the branch pipe;
a pair of seal rings fitted over the first and second ends of the fluid transport pipe, the seal rings being slidable over an outer peripheral face of the fluid transport pipe so as to respectively seal a border portion between the first open end of the joint body and the first end of the fluid transport pipe and a border portion between the second open end of the joint body and the second end of the fluid transport pipe;
a valve disposed inside the joint body to be pivotable therein to control flow of fluid running inside the joint body; and
a seat provided within the joint body;
wherein the seat includes;
a third seat portion for contacting and supporting the valve at a predetermined angular position of the valve in such a way as to shut the third open end of the joint body from the fluid running between the first open end and the second open end,
a first seat portion for contacting and supporting the valve at a further predetermined angular position of the valve in such a manner as to shut the first open end from the fluid running between the second open end and the third open end, and
a second seat portion for contacting and supporting the valve at a still further predetermined angular position of the valve in such a manner as to shut the second open end from the fluid running between the third open end and the first open end.

2. A fluid transport pipe joint for use in connecting a branch pipe to an existing fluid transport pipe, comprising:
a joint body having first and second open ends connectable respectively with first and second ends of the fluid transport pipe formed by cutting away a predetermined length portion from the pipe, and a third open end connectable with the branch pipe;
a valve disposed inside the joint body to be pivotable therein about a pivotal axis to control flow of fluid running inside the joint body, said pivotal axis of the valve being offset from a common axis of said first and second open ends; and
a seat provided within the joint body;
wherein the seat includes;
a third seat portion for contacting and supporting the valve at a predetermined angular position of the valve in such a way as to shut the third open end of the joint body from the fluid running between the first open end and the second open end,
a first seat portion for contacting and supporting the valve at a further predetermined angular position of the valve in such a manner as to shut the first open end from the fluid running between the second open end and the third open end, and
a second seat portion for contacting and supporting the valve at a still further predetermined angular position of the valve in such a manner as to shut the second open end from the fluid running between the third open end and the first open end.

3. The fluid transport pipe joint according to claim 1 or 2, wherein the valve includes an elastic seal, each of the seat portions contacting and supporting the valve via the elastic seal of the valve, and each of the seat portions includes a chamfered portion for smoothly receiving the elastic seal at each angular position of the valve by each seat portion.

4. The fluid transport pipe joint according to claim 1 or 2, wherein there is provided a valve rod for rotatably manipulating the valve from the outside of the joint body, the valve rod being provided separately from the valve and being coupled with the valve by fastening means.

5. The fluid transport pipe joint according to claim 4, wherein the valve rod includes a flange portion having a plurality of screw holes and a valve rod body continuously extending from the flange portion, the valve rod body including a manipulation input portion for receiving the rotational manipulating force from the outside of the joint body.
